(19) United States
(12) Patent Application Publication
(10) Pub. No.: US 2006/0143021 A1
(43) Pub. Date: Jun. 29, 2006

(54) Procedure and interactive communication unit for initiating purchase through the internet between a seller and a buyer

(76) Inventor: Andras Vilmos, Budapest (HU)

Correspondence Address: SNELL & WILMER;ONE ARIZONA CENTER, 400 EAST VAN BUREN, PHOENIX, AZ, 850040001, US

(21) Appl. No.: 10/537,628

(22) PCT Filed: Nov. 19, 2003
(86) PCT No.: PCT/HU03/00098

§ 371 Date: Nov. 30, 2005

(30) Foreign Application Priority Data
Dec. 3, 2002 (HU) P 0204174

(51) Int. Cl. G06Q 99/00; G06F 15/16

(52) U.S. Cl. 705/1; 709/203

(57) ABSTRACT

The invention relates to a procedure according to the invention for initiating purchase through the Internet between a seller and a buyer, in the course of which the virtual data units of the seller's products and/or services is sent to the buyer's communication unit through a signal forwarding network, and at least a part of the virtual data units of the products and/or services is displayed on a display unit, and using the signal forwarding network an information technology command channel needed to initiate purchase is established between the seller's communication unit abd the buyer's communication unit, and the purchase is initiated by activating the information technology command channel, characterised by that before starting the purchase an internal transaction initiating interface (14) is created deriving from the buyer's (1) communication unit (10) and only accessible by the buyer's (1) comunication unit (10), the transaction initiating interface (14) is provided with an exclusive address (14a), the exclusive address (14a) of the transaction initiating interface (14) is allocated to the command channel (31), and the purchase is initiated by activating the transaction initiating interface (14).

The subject of the invention relates to a procedure for initiating purchase through the Internet between a seller and a buyer, in the course of which the virtual data units of the seller's products and/or services is sent to the buyer's communication unit through a signal forwarding network, and at least a part of the virtual data units of the products and/or services is displayed on a display unit, and using the signal forwarding network an information technology command channel needed to initiate purchase is established between the seller's communication unit and the buyer's communication unit, and the purchase is initiated by activating the information technology command channel.

Furthermore the invention relates to an interactive communication unit between a seller and a buyer to facilitate the initiation of a purchase through the Internet, which comprises a display unit divided into one or more active image fields and one or more passive image fields, at least on a part of the passive image fields of the display unit the virtual data units of the seller's products and/or services are displayed, and on at least one of the active image fields the command elements for instructing the buyer's communication unit are arranged.

With the development of telecommunications and computer technology and with the globalisation of commercial activity solutions for supporting the so-called “electronic purchasing possibilities” have gained. increasing ground. The main point of a group of these is that the seller offers his/her products or services on his/her Internet homepage giving a description and pictures of them. The list and other data of the products or services shown on the seller's homepage is accessible for the potential buyer's through a computer signal forwarding network. If the buyer—sitting in front of his/her own computer—chooses one of the offered goods and intends to buy it, he/she can initiate purchase through the connection established between the seller's and the buyer's computer, suitable for signal forwarding. In order to initiate purchase, the answers given to the questions written by the seller and appearing on the screen of the buyer's computer and an impulse generated in the virtual evaluation zone situated in the so-called “passive image field” of the screen displaying the information sent by the seller are needed. Such solutions are described in publication documents No. WO 97/29584, WO 99/19821 and WO 00/23928.

However, the disadvantage of purchase initiating procedures of this character is that from the buyer's side a great deal of confidential information must be sent to the seller temporarily, which is difficult, involves numerous error possibilities, and in an excessive case unauthorised parties may also have access to the data, may provide a possibility for misuse.

A further deficiency of the known solutions is that their application is mainly controlled by the seller, so the buyer can only proceed according to the commands, which in certain cases, because of the confidential nature of the required information, may result in a failure of carrying out the purchase.

With the solution according to the invention our aim was to overcome the deficiencies of the known solutions and the tools used for their realisation, and to create a version, which makes it possible for the buyer to send his/her own confidential data to the seller securely, simply and quickly, where the data only include the necessary amount of information for concluding the business transaction.

The procedure according to the invention is based on the recognition that if the data needed to initiate purchase is stored in the buyer's communication unit in advance in one unit so that it can be forwarded between the buyer's and the seller's communication unit exclusively on the basis of the seller's command, in a given case in an appropriately coded form, and the command interface used for starting this data forwarding process is created and placed on the buyer's communication unit different to the known solutions, and the data is sent to the seller using a procedure different to that known, then the task can be solved.

In accordance with the set aim the procedure according to the invention for initiating purchase through the Internet between a seller and a buyer,—in the course of which the virtual data units of the seller's products and/or services is sent to the buyer's communication unit through a signal forwarding network, and at least a part of the virtual data units of the products and/or services is displayed on a display unit, and using the signal forwarding network an information technology command channel needed to initiate purchase is established between the seller's communication unit and the buyer's communication unit, and the purchase is initiated by activating the information technology command channel,—is based on the principle that before starting the purchase an internal transaction initiating interface is created deriving from the buyer's communication unit and only accessible by the buyer's communication unit, the transaction initiating interface. is provided with an exclusive address, the exclusive address of the transaction initiating interface is allocated to the command channel, and the purchase is initiated by activating the transaction initiating interface.

A further criterion of the procedure according to the invention may be that the transaction initiating interface is displayed on the display unit of the buyer's communication unit, practically in its active image field allocated to the buyer.

In another realisation of the procedure one of the keys belonging to the keyboard of the buyer's communication unit is set as a transaction initiator.

In accordance with the further set aim the interactive communication unit between a seller and a buyer according to the invention to facilitate the initiation of a purchase through the Internet,—which comprises a display unit divided into one or more active image fields and one or more passive image fields, at least on a part of the passive image fields of the display unit the virtual data units of the seller's products and/or services are displayed, and on at least one of the active image fields the command elements for instructing the buyer's communication unit are arranged,—is created in a way that the command elements of the active image fields of the display unit are supplemented with at least one transaction initiating interface.

A further criterion of the communication unit according to the invention may be that a name list, which is temporarily displayable on the display unit, is allocated to the transaction initiating interface.

The advantage of the procedure according to the invention is that with its use the buyer's data can be sent to the seller with greater simplicity, speed and less opportunity for errors, beside a greater degree of data security, and in this way the reliability of making purchases on the Internet can be significantly increased, which may result in the increasing of the number of purchases.

A further advantage is that due to the different construction and method of operation of the transaction initiating interface used for initiating purchase the buyer has a greater feeling of comfort and security, which can be regarded as a basic requirement in the case of electronic business transactions of this character.

It must also be regarded as favourable that due to the special character of the procedure there is no need to change or modify the connection establishing or maintaining equipment used so far to make purchases on the Internet, because the changes needed for the procedure can be easily made, and they only result in changes at program level in the buyer's and in certain cases in the seller's communication unit.

Below the procedure according to the invention and the communication unit suitable for its realisation is described in detail in connection with an example, on the basis of a drawing. In the drawing

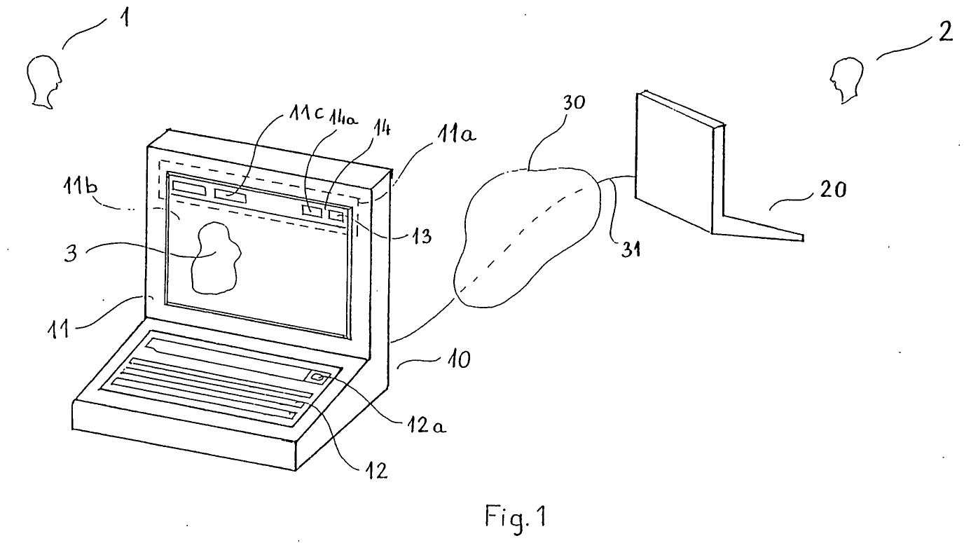

FIG. 1 is the plan view of a version of the communication unit according to the invention.

FIG. 1 shows the tools needed for the realisation of the procedure according to the invention and a possible arrangement of them. It can be seen that as is usual in the course of purchases made on the Internet in this case too the buyer 1 has got a communication unit 10, and the seller 2 has got a communication unit 20 too. The seller's 2 communication unit 20—in a way known in itself—stores and forwards the virtual data units 3 of the products or services offered by the seller 2, while the buyer's 1 communication unit 10 receives and displays the virtual data units 3. Between the communication unit 10 and the communication unit 20 connection realising data transfer can be established with the help of the signal forwarding network 30, where direct connection between the buyer's 1 communication unit 10 and the seller's 2 communication unit 20 is provided by the information technology command channel 31. The signal forwarding network 30 can be an optional telecommunication or other data transfer network, on which direct Internet connection according to the information technology command channel can be established.

FIG. 1 shows the display unit 11 and keyboard 12 of the buyer's 1 communication unit 10. The display unit 11 is divided into an active image field 11a and a passive image field. The passive image field 11b of the display unit 11 is suitable for displaying virtual data units 3, while the command elements 11c, practically the elements of the so-called “scroll bar”, used for controlling the buyer's 1 communication unit 10 are situated on the active image field 11a. These command elements 11c include a transaction initiating interface 14, which has its own exclusive address 14a This exclusive address 14a can be interpreted by the communication unit 10, and it also make it possible for the transaction initiating interface 14, as a signal generator, to connect to the information technology command channel 31 of the signal forwarding network 30 directly or indirectly.

In the case of this construction example a name list 13 also belongs to the transaction initiating interface 14, which name list is a menu point that can be activated temporarily from the active image field 11a of the display unit 11, and its task is to store the buyer's 1 account holding bank partners together with the data of the account holding banks.

Furthermore, in the case of this version there is a key 12a with an independent function on the keyboard 12 of the buyer's 1 communication unit 10, and its task is to make it possible to create the transaction initiating surface 14 on the keyboard 12 too. With the key 12a of the keyboard 12 the transaction initiating interface 14 is realised by impulse generating surfaces getting in contact with each other when the key 12a is pressed, and the connection of these impulse generating surfaces generate the purchase initiating signal. Consequently the key 12a of the keyboard 12 must also be directly or indirectly connected to the information technology command channel 31 of the signal forwarding network.

It must be pointed out here that the buyer's 1 communication unit 10 and the seller's 2 communication unit 20 are ordinary computers, e.g.: PC-s, but independent control software must be used for establishing the transaction initiating interface 14 and displaying is in the active image field 11a of the display unit, for the “personification” of the key 12a on the keyboard 12 and for the appropriate connection of these with the information technology command channel 31.

Below the invention is described in detail in connection with procedure examples.

### EXAMPLE 1

In the case of this version of the procedure first the buyer's 1 communication unit 10 was switched on, then the transaction initiating interface 14 was displayed in the active image field 11a of the display unit 11. After this the important data of the buyer's 1 account holding banks was entered in the name list 13 allocated to the transaction initiating interface 14, such as the name of the bank, the number of the buyer's account kept at the given bank and other necessary data identifying the buyer 1.

Then, in the course of browsing on the Internet, the virtual data units 3 stored in the seller's 2 communication unit 20 were sent to the passive image field 11b belonging to the display unit 11 of the buyer's 1 communication unit 10 through the signal forwarding network 30 in a way known in itself and for this reason not described in detail here. In the passive image field 11b, after an inquiry was made relating to the products and services displayed with the help of the virtual data unit 3, the cursor used for making commands was moved onto the transaction initiating interface 14 of the active image field 11a of the display unit 11, and by moving the cursor, in this case by pressing the buttons of the mouse, a signal was activated on the transaction initiating interface 14. As an effect of the signal activated on the transaction initiating interface 14 the name list opened 13, and the data of the bank carrying out the settlement of the purchase price was selected, and then together with the buyer's 1 further confidential data, using the exclusive address 14a of the transaction initiating interface 14, it was forwarded to the information technology command channel 31 of the signal forwarding network 30. Through the information technology command channel 31 the purchase initiating signal and the relating data was sent to the seller's 2 communication unit 20, and in this was the purchase was initiated.

### EXAMPLE 2

In the case of this version of the procedure we proceeded in a similar way as described above, with the difference that first the buyer's 1 communication unit 10 was switched on, and a certain key 12a of the keyboard was determined as a transaction initiator 14. Then the name list 13 was allocated to the key 12a of the keyboard 12, and in the same was as described in the example above the important data of the buyer's 1 account holding banks was entered in the name list 13, such as the name of the bank, the number of the buyer's account kept at the given bank and other necessary data identifying the buyer 1.

In the case of the realisation of this procedure, in the course of browsing on the Internet, the virtual data units 3 stored in the seller's 2 communication unit 20 were forwarded to the passive image field 11b belonging to the display unit 11 of the buyer's 1 communication unit 10 through the signal forwarding network 30. And when on the basis of a virtual data unit 3 the purchase of a given product or service was initiated, the key 12a serving as a transaction initiator 14 on the keyboard 12 was pressed. When the key 12a was pressed, it generated a signal, which was forwarded to the information technology command channel 31, and through the signal forwarding network 30 it reached the seller's 2 communication unit 20, and in this way the purchase was initiated.

The procedure according to the invention can be used well for initiating purchases on the Internet in a quick and simple way, which is reliable form the aspect of data security.

1. Procedure according to the invention for initiating purchase through the Internet between a seller and a buyer, in the course of which the virtual data units of the seller's products and/or services is sent to the buyer's communication unit through a signal forwarding network, and at least a part of the virtual data units of the products and/or services is displayed on a display unit, and using the signal forwarding network an information technology command channel needed to initiate purchase is established between the seller's communication unit and the buyer's communication unit, and the purchase is initiated by activating the information technology command channel, characterised by that before starting the purchase an internal transaction initiating interface 14 is created deriving from the buyer's 1 communication unit 10 and only accessible by the buyer's 1 communication unit 10, the transaction initiating interface 14 is provided with an exclusive address 14a, the exclusive address 14a of the transaction initiating interface 14 is allocated to the command channel 31, and the purchase is initiated by activating the transaction initiating interface 14.

2. Procedure as in claim 1, characterised by that the transaction initiating interface 14 is displayed on the display unit 11 of the buyer's 1 communication unit 10, practically in its active image field 11a allocated to the buyer 1.

3. Procedure as in claim 1, characterised by that one of the keys 12a belonging to the keyboard 12 of the buyer's 1 communication unit 10 is set as a transaction initiator 14.

4. Procedure as in claim 2, characterised by that one of the keys 12a belonging to the keyboard 12 of the buyer's 1 communication unit 10 is set as a transaction initiator 14.

5. Interactive communication between a seller and a buyer to facilitate the initiation of a purchase through the Internet, which comprises a display unit divided into one or more active image fields and one or more passive image fields, at least on a part of the passive image fields of the display unit the virtual data units of the seller's products and/or services are displayed, and on at least one of the active image fields the command elements for instructing the buyer's communication unit are arranged, characterised by that that the command elements 11c of the active image fields 11a of the display unit 11 are supplemented with at least one transaction initiating interface 14.

6. Communication unit as in claim 5, characterised by that that a name list 13, which is temporarily displayable on the display unit 11, is allocated to the transaction initiating interface 14.
